(19) United States
(12) Patent Application Publication
(10) Pub. No.: US 2017/0280940 A1
(43) Pub. Date: Oct. 5, 2017

(54) CULINARY VESSELS WITH QUICK RELEASE DETACHABLE HANDLES

(71) Applicant: Justin Quinn, St. Louis, MO (US)

(72) Inventor: Justin Quinn, St. Louis, MO (US)

(21) Appl. No.: 15/475,973

(22) Filed: Mar. 31, 2017

Related U.S. Application Data
(60) Provisional application No. 62/315,974, filed on Mar. 31, 2016.

(51) Int. Cl. A47J 45/07; B65D 21/02; B65D 25/28; A47J 45/06

(52) U.S. Cl. CPC A47J 45/07; A47J 45/068; B65D 21/0233; B65D 25/28

(57) ABSTRACT

Disclosed are exemplary embodiments of quick release detachable handles for culinary vessels. Also disclosed are exemplary embodiments of culinary vessels that include quick release detachable handles.

### CROSS-REFERENCE TO RELATED APPLICATION

This application claims priority to and the benefit of U.S. Provisional Patent Application No. 62/313,974 filed Mar. 31, 2016. The entire disclosure of the above application is incorporated herein by reference.

### FIELD

The present disclosure relates to quick release detachable handles for culinary vessels.

### BACKGROUND

This section provides background information related to the present disclosure which is not necessarily prior art.

There have been many variations of frying pans, pots, and various other culinary vessels with handles. Some handles are detachable, secured, or even a part of a one-piece design as an entire system. Considering detachable handles, the majority require separate pieces such as lugs and bolts to combine the handle to the culinary vessel. For detachable handles that do not require such integration, the detachable handle typically tends to clamp somewhere either in the vessel or on a designated area on the outside of the vessel. Issues with conventional detachable handles are stability and ease of operation.

Culinary vessels that have detachable handles have been only marginally effective. For example, a conventional detachable handle that clips on the inside of the culinary vessel may contaminate the contents within the culinary vessel. Some conventional detachable handles are only attachable to a predetermined centered exterior area may prevent contamination and provide stability. In which case, such handles lack continuity and ease of management. Other conventional detachable handles are configured to grab an outer rim of a culinary vessel but lack quick release mechanisms for ease of usability.

Some prior attempts at quick release mechanisms for detachable handles include springs to provide pressure, plastic detachments, clipping mechanisms with tension and force dictated by the power of an interior spring, and simple mechanical designs that use friction, gravity, and hooking. But these prior detachable handles have been designed for specific culinary vessels to provide maximum support needed, and therefore each handle is usable with only one specific type of vessel.

### DRAWINGS

The drawings described herein are for illustrative purposes only of selected embodiments and not all possible implementations, and are not intended to limit the scope of the present disclosure.

FIG. 1 is a perspective view of a quick release detachable handle 1 according to an exemplary embodiment in which the handle 1 has a relatively short and wide configuration. The handle 1 includes a quick release mechanism and four contact points (e.g., upper and lower pairs of spaced-apart contact points defining a relatively wide gripping jaw, etc.) for securely attaching the handle 1 to a portion (e.g., curved portion, perimeter rim, etc.) of a culinary vessel 30.

FIG. 2 is an exploded perspective view of the handle 1 shown in FIG. 1, and also illustrating pads 11 that are positionable along gripping surfaces of the handle's pressure members or clamping members 10, 12 for increasing or maximizing the handle's grip onto the culinary vessel 30.

FIG. 3 is a top view of a quick release detachable handle 101 according to another exemplary embodiment in which the handle is longer than the handle shown in FIG. 1 and includes pads 111 that are larger (e.g., wider, longer) than the pads 11 shown in FIGS. 1 and 2. The handle 101 shown in FIG. 3 includes a quick release mechanism and four contact points for securely attaching the handle 101 to the upper surface and the lower surface 133 of a gripping flare, flange, shoulder, curved perimeter portion, or other portion of a culinary vessel 130.

FIG. 4 is an exploded perspective view of the handle 101 shown in FIG. 3.

FIG. 5 is a top view of a quick release detachable handle 201 according to another exemplary embodiment in which the handle 201 includes a wide pad 211. The handle 201 includes a single upper pressure or clamping member 210 and a single lower pressure or clamping member, which are operable for creating a singular force point or area for securely attaching the handle 201 to the upper surface and lower surface 233 of a gripping flare, flange, shoulder, curved perimeter portion, or other portion of a culinary vessel 230.

FIG. 6 is a side view of a handle 301 according to another exemplary embodiment in which the handle 301 includes a contact surface 316 (e.g., pad, etc.) at an end portion of a segment or arm 313 for providing stability and additional leverage when the handle 301 is attached to a culinary vessel 330 (e.g., curved perimeter edge or other portion of a frying pan, etc.).

FIG. 7 is an exploded perspective view of the handle 301 shown in FIG. 6.

FIGS. 8 and 9 are upper and lower perspective views, respectively, of a quick release detachable handle 401 according to an exemplary embodiment in which the handle 401 includes a quick release mechanism for attaching the handle 410 to a rim or edge portion 432 of a culinary vessel 430.

FIG. 10 is an exploded perspective view of the handle 401 shown in FIG. 8, and illustrating the handle's interface 414, trigger 425 (e.g., finger activatable trigger or lever, etc.), securing piece 410, and grip or handle portion 415.

FIG. 11 is a perspective view of the handle 401 shown in FIG. 8, and illustrating the handle's configuration that allows for an ergonomic hand placement.

FIGS. 12A and 12B are perspective views showing the handle 401 in FIG. 8 attached along a rim, flange, shoulder, or perimeter edge portion 432 of a culinary vessel 430.

FIGS. 13A and 13B are perspective views of the handle 401 shown in FIG. 8, and illustrating an indicator 434 for indicating when the handle 401 is secured onto the rim 432 of the culinary vessel 430. In FIG. 13A, the indicator 434 is not visible thereby indicating to a user that the handle 401 is not securely attached to the culinary vessel 430. In FIG. 13B, the indicator 434 is visible through the opening 436 in the handle 401 thereby indicating to the user that the handle 401 is securely attached to the culinary vessel 430.

FIG. 14 is a perspective view of a quick release detachable handle 501 according to an exemplary embodiment in which the handle 501 includes a quick release mechanism for attaching (e.g., clamping, etc.) the handle 501 to an overhanging lip 532 of a culinary vessel 530. The handle 501 is configured with a streamlined ergonomic grip or handle portion 515 and a trigger locking mechanism or lever 525. During use, the handle 501 may be operable for transferring pick up forces to the surface of the pot or other culinary vessel 530.

FIGS. 15A and 15B are perspective views showing the handle 501 in FIG. 14. FIG. 15A shows the handle 501 in an open or unlocked condition in which the handle 501 is unlocked or unlatched from the pot 530 and the trigger or lever 525 is not activated. FIG. 15B shows the handle 501 in a closed or locked condition in which the trigger or lever 525 is activated and the handle 501 is locked onto the pot 530.

FIG. 16 is a perspective view of a quick release detachable handle 601 according to an exemplary embodiment in which the handle 601 includes a quick release mechanism for attaching (e.g., clamping, etc.) the handle to a portion 632 of a culinary vessel 630 (e.g., pot, etc.). The handle 601 is configured with an ergonomic grip or handle portion 615 and a switch lock mechanism 625. During use, the handle 601 may be operable for transferring pick up forces to the surface of the pot or other culinary vessel 630.

FIGS. 17A and 17B are perspective views showing the handle 601 in FIG. 16. FIG. 17A shows the handle 601 in an open or unlocked condition in which the handle 601 is unlocked or unlatched from the pot 630 and the slide switch or button 625 is not activated. FIG. 17B shows the handle 601 in a closed or locked condition in which the slide switch or trigger 625 is activated and the handle 601 is locked onto the pot 630.

### DETAILED DESCRIPTION

Example embodiments will now be described more fully with reference to the accompanying drawings.

After recognizing that a need exists for a cooking utility that provides uniformity and ease of handling, the inventor hereof developed quick release detachable handles for culinary vessels that are configured with a quick release and stability utility as compared to other prior handles as disclosed above. As disclosed herein, exemplary embodiments are configured to be used in connection with frying pans, pots, or other kitchen heating vessels for the purpose of baking, frying, warming, and various other culinary achievements. For example, an exemplary embodiment of a handle is configured such that it may be relatively quickly released from a vessel omni-perpendicularly from the vessel.

Disclosed herein are methods and quick release detachable handles (broadly, apparatus) for culinary use that allow for ease and standard storage, maintenance, and safety for culinary cooking vessels. The handles may be usable with multiple different vessels within a single cooking system. With the handles removed, the culinary vessels may be easily stored, maintained, and transition from various culinary cooking mediums with ease. For example, the culinary vessels with the handles removed may be conveniently storable in a stacked arrangement (e.g., without any protruding handles on the culinary vessels that would prevent stacking, etc.) with the largest culinary vessel on the bottom of the stack and with the smallest culinary vessel on top of the stack. The unique handle to vessel quick release coupling mechanisms disclosed herein allows different handle combinations to be used to fulfill a user's culinary needs. The quick release detachable handles can be used in various type of load, storage, and cooking transferable configurations, thus overcoming shortcomings and disadvantages found with prior handles. The quick release detachable handles disclosed herein may be used in a universal system that can be configured by the user in any one of a plurality of different combinations. For example, an exemplary embodiment may include a system or kit comprising one or more quick release detachable handles and a plurality of culinary vessels having different configurations (e.g., in different shapes, sizes, intended uses, etc.). In this example, the one or more quick release detachable handles may be interchangeably usable with any one of the different culinary vessels.

Exemplary embodiments disclosed herein provide an improvement of cookware through the deployment of quick release detachable handles. For example, a handle may be released quickly and be adjusted in any one of a plurality of different configurations on a culinary vessel attachment region though a robust gripping flare. The cooking vessel may be made of a conventional quality heat management material and include an extended upper flare that may be used for maneuverability and for attachment of a handle according to exemplary embodiments. The handles may be configured or adapted to provide a firm securable grip thus making the cooking vessel maintain its traditional use and stability. The handle may be configured or adapted to lock in the position desired by the user. An exemplary embodiment of a handle may include two controlling movable levers (or first and second or upper and lower levers) that may be squeezed together by a user's hand.

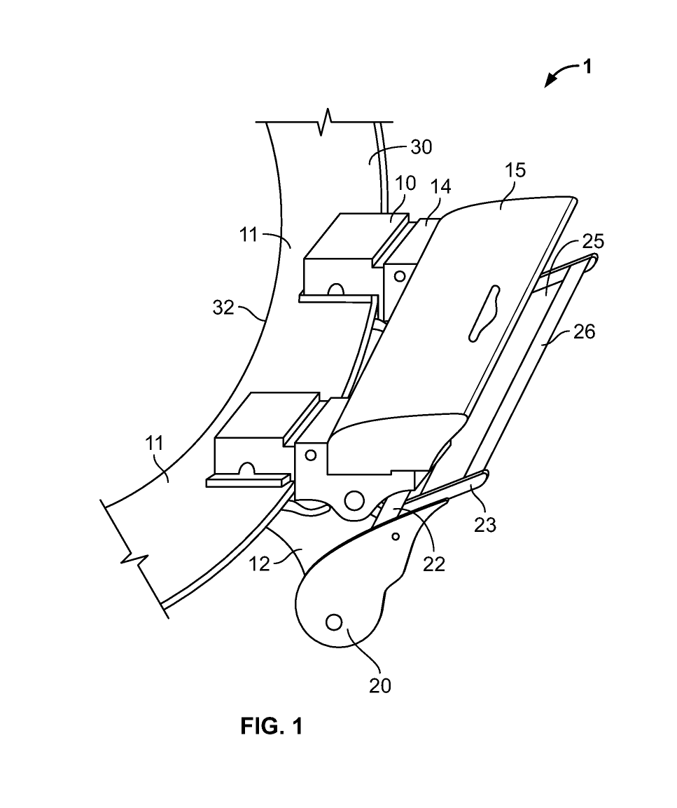

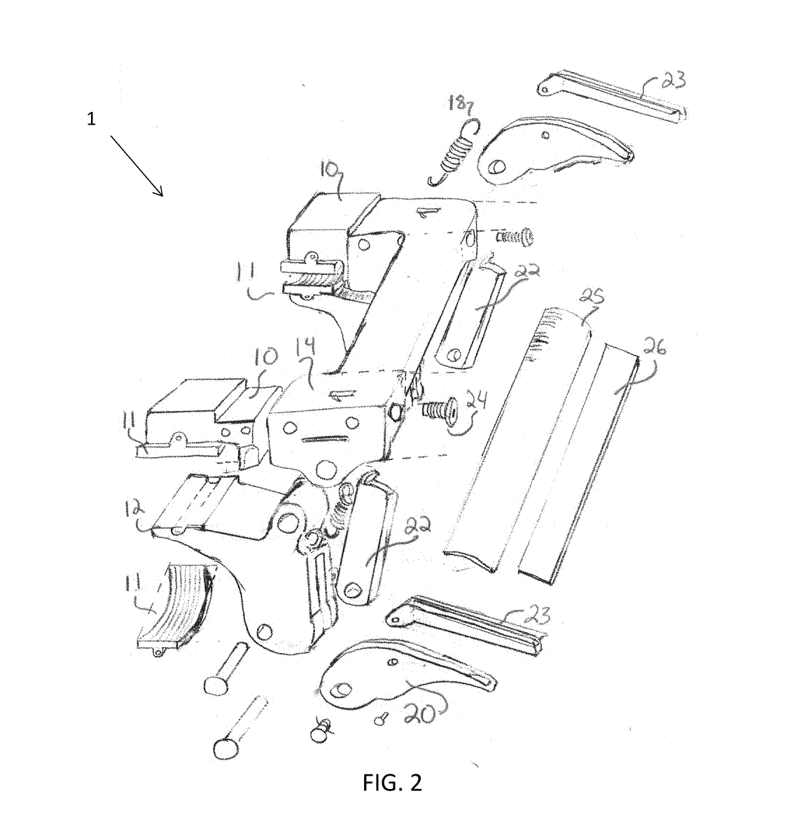

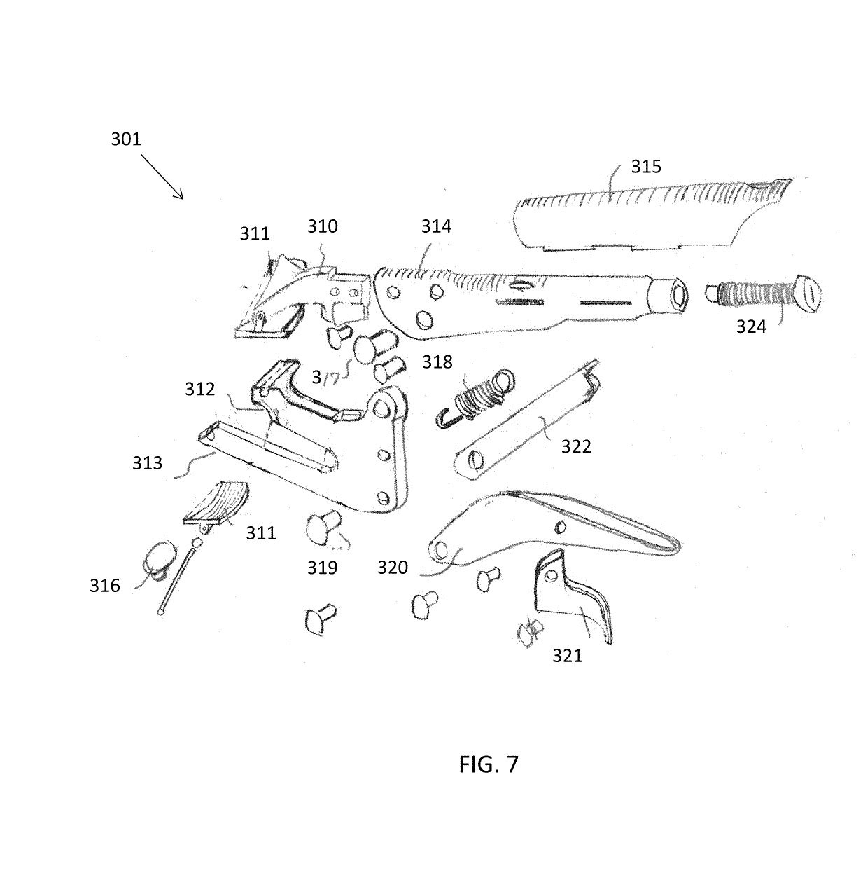

With reference now to the figures, FIGS. 1 and 2 illustrate an exemplary embodiment of a handle 1 embodying one or more aspects of the present disclosure. As shown in FIG. 1, the handle 1 includes upper and lower (or first and second) pressure or clamping members 10 and 12 (broadly, engagement members) secured to the handle 1 by a main body 14. The pressure or clamping members 10, 12 may be arranged and configured as shown in FIGS. 1, 4, and 7. The handle may include an a stability enhancer in alternative embodiments, such as the handle 401 including a stability enhancer 413 as shown in FIG. 7, etc.

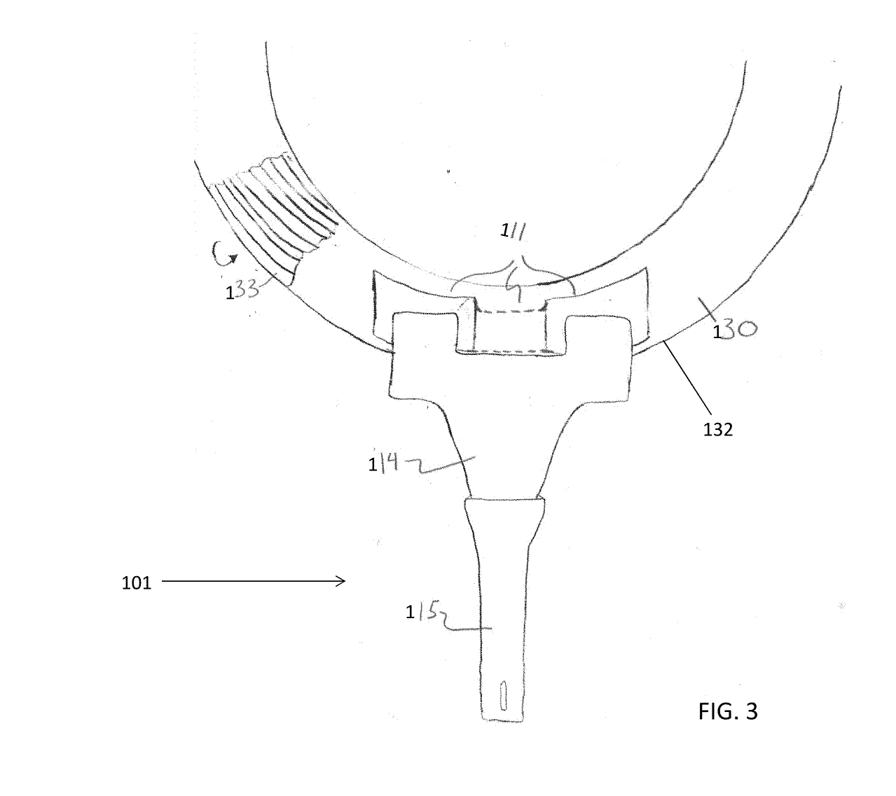

The handle 1 may include pads 11 that are configured or designed to displace the force of the handle 1 to provide an increased or maximum grip onto the cooking vessel 30. As shown in FIG. 2, the pads 11 may include grooves (e.g., grooves defined between ribs, etc.) that run parallel, perpendicular, or multi-directional with the gripping flare 32 of the cooking vessel 30 to further secure the support and force of the joining parts. The pattern on pads 11 may be configured to match the pattern on the upper and lower (or first and second) surfaces of the gripping flare 32 of the cooking vessel 30. See, for example, the pattern on the lower surface 133 of the gripping flare 132 of the cooking vessel 130 shown in FIG. 3. The pads 11 along the pressure or clamping members 10, 12 of the handle 1 may include ridges that lockingly engage with corresponding grooves along the upper and lower surfaces of a portion 32 (e.g., gripping flare, shoulder, flange, etc.) of the cooking vessel 30. The engagement of the ridges and grooves may provide a more secure attachment of the handle 1 to the cooking vessel 30.

The force of the pressure members 10, 12 secures the handle 1 to the gripping flare or other portion 32 of the culinary vessel 30 as compatible functions for flush engagement of the vessel 30 to the handle 1.

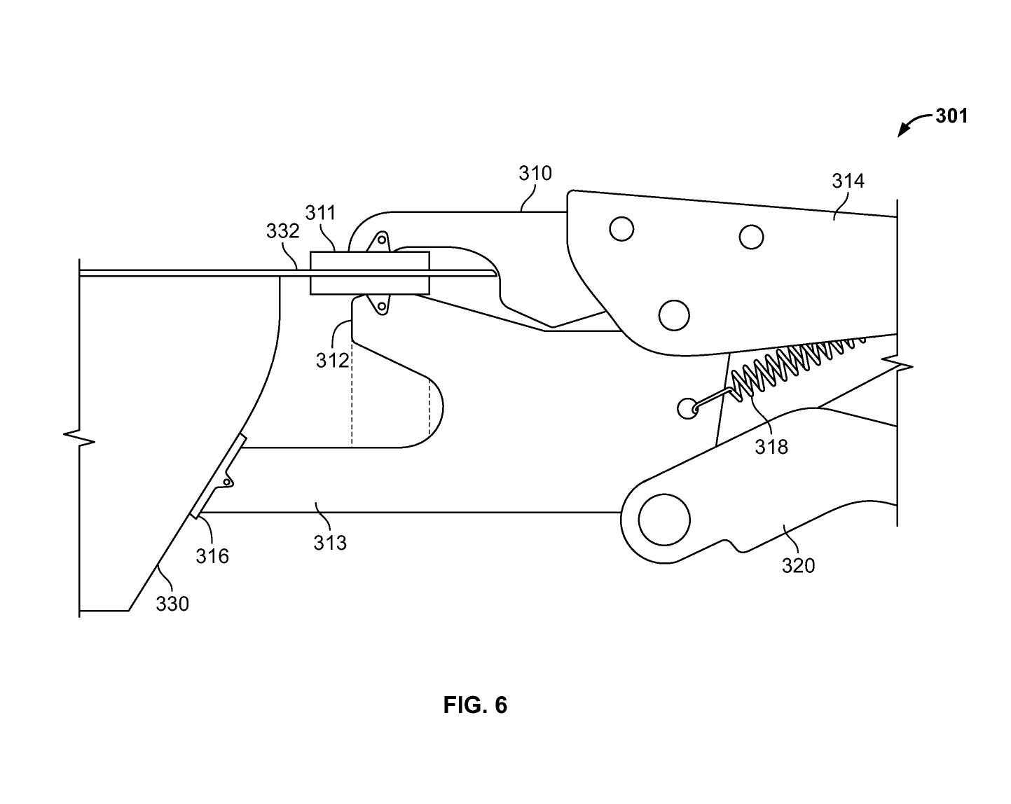

A third pressure point may be provided in some exemplary embodiments (e.g., 413 in FIG. 6, etc.) that further stabilizes and displaces force to create security and control of the cooking system.

As shown in FIG. 2, the handle 1 includes a spring member 18 and release trigger or lever 26 that assists the quick release action of the handle 1 from the culinary vessel 30. The handle 1 also includes a crevice along a handle bottom arm 20 and a resistance bar 22 in line with the trigger mechanism of 21 that allows for stability and rapid locking and de-locking of the handle 1 to the culinary vessel 30. The functional grip or handle portion 15 allows for the comfort and usability of the cooking system.

Joints may be used that allow for the motion of the handle 1. The joints may be adjusted for improved or optimum use. For example, FIG. 7 shows rotatable or pivotable joints provided by rivets 317 and 319.

In exemplary embodiments, the quick release handle design provides the capability for the handle to transfer from any culinary vessel designed within the system. Therefore, other culinary vessels (e.g., frying pans, pots, woks, etc.) with an extended gripping flare may be compatible and usable with a handle disclosed herein.

In exemplary embodiments, the handle may have an indent region on a pressure or clamping member to easily guide the vessel and further secure the cooking system.

In exemplary embodiments, the handle may include pads configured or designed to interchangeably fit any a plurality of different culinary vessels.

With continued reference to FIGS. 1 and 2, the quick release detachable handle 1 has a relatively short and wide configuration. The handle 1 includes a quick release mechanism that allows a user to readily quickly and easily attach the handle 1 to the culinary vessel 30 and then later detach and remove the handle 1 from the culinary vessel 30. More specifically, the handle 1 includes the functional grip or handle portion 15, a lever 25, and a release trigger or lever 26. To attach the handle 1 to the culinary vessel 30, the grip 15 and lever 25 may be squeezed together by a user's single hand to thereby secure the handle 1 to the culinary vessel 30. To release the lever 25 and allow the handle 1 to be relatively quickly removed from the culinary vessel 30, a user may move the release trigger 26 downward relative to the lever 25.

In this example, the handle 1 includes a relatively wide gripping jaw that defines a first or upper pair of spaced-apart contact points and a second or lower pair of spaced-apart contact points. Accordingly, the handle 1 includes four contact points for securely attaching the handle to a portion (e.g., a curved portion, etc.) of the culinary vessel 30. The gripping jaw includes or is defined by the upper and lower pressure or clamping members 10 and 12 (broadly, engagement members).

Advantageously, the large width of the gripping jaw (e.g., wider than a width and/or a length of the grip portion 15, etc.) allows the handle 1 to be relatively easily attached to the culinary vessel 30 without requiring an exactly accurate placement of the handle 1 onto the portion of the culinary vessel 30 to which it will be attached. In addition, the handle 1 is configured such that the user will advantageously hold the grip 15 and levers 25, 26 closed while carrying the culinary vessel 30 via the handle 1, thus helping to inhibit or prevent an accidental release of the quick release mechanism and detachment of the handle 1 from the culinary vessel 30. In addition, the handle 1 may be attached anywhere along the circumference of the portion 32 of the culinary vessel 30 in this example.

FIG. 2 shows pads 11 that are positionable along the gripping surfaces of the handle's pressure or clamping members 10, 12 for increasing or maximizing the handle's grip onto the culinary vessel 30. In this example, the pads 11 may include a pattern of ridges and groves that correspond with a pattern of grooves and ridges along the surfaces of the attachment portion (e.g., surfaces 133 (FIG. 3) of a culinary vessel's gripping flare, shoulder, flange, etc.) of the culinary vessel 30 to which the handle 1 will be attached. The ridges of the pads 11 along the jaws 10, 12 of the handle 1 may lockingly engage with the corresponding grooves along the upper and lower surfaces of the attachment portion of the cooking vessel 30 Likewise, the ridges along the upper and lower surfaces of the attachment portion of the cooking vessel 30 may lockingly engage with the corresponding grooves defined between the grooves of the pads 11. The engagement of the ridges and grooves may provide a more secure attachment (e.g., inhibit or prevent slippage, etc.) of the handle 1 to the cooking vessel 30. In addition, the pads 11 may comprise a high friction or anti-slip material (e.g., rubber, elastomeric material, etc.) for helping to inhibit or prevent slippage or movement of the pads 11 along the culinary vessel's attachment portion after the handle 1 has been secured to the culinary vessel 1.

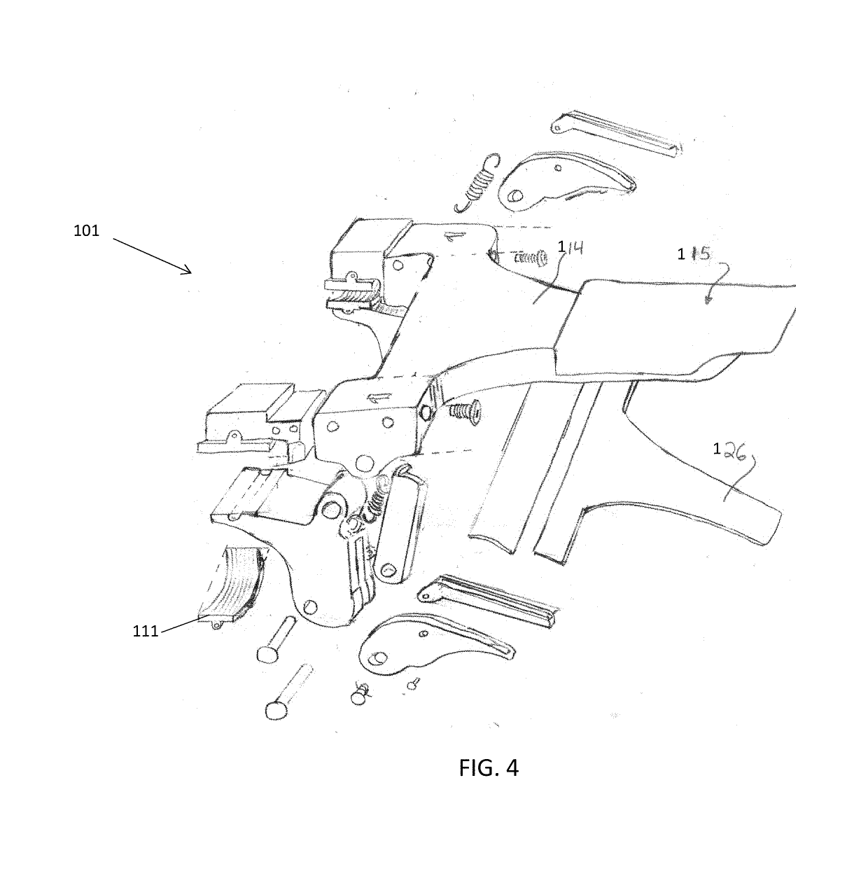

FIGS. 3 and 4 illustrate another exemplary embodiment of a handle 101 embodying one or more aspects of the present disclosure. As shown in FIG. 3, the handle 101 includes a relatively long grip or handle portion 115 and a relatively long lever 126. The handle 101 includes pads 111 that are larger (e.g., wider, longer) than the pads 11 shown in FIGS. 1 and 2.

Other than the longer grip or handle portion 115, longer lever 126, and larger pads 111, the handle 101 may include features (e.g., main body 114, four contact points defined by a wide jaw, etc.) similar or substantially identical to the corresponding features of the handle 1. For example, the handle 101 also includes a quick release mechanism and four contact points for securely attaching the handle 101 to the upper surface and the lower surface 133 of a gripping flare, flange, shoulder, or other portion 132 (e.g., curved portion around the perimeter, etc.) of the culinary vessel 130. Also, for example, the handle 101 is configured such that the user will advantageously hold the grip 115 and levers 126 closed while carrying the culinary vessel 130 via the handle 101, thus helping to inhibit or prevent an accidental release of the quick release mechanism and detachment of the handle 101 from the culinary vessel 130. In addition, the handle 101 may also be attached anywhere along the circumference of the portion 132 of the culinary vessel 130 in this example.

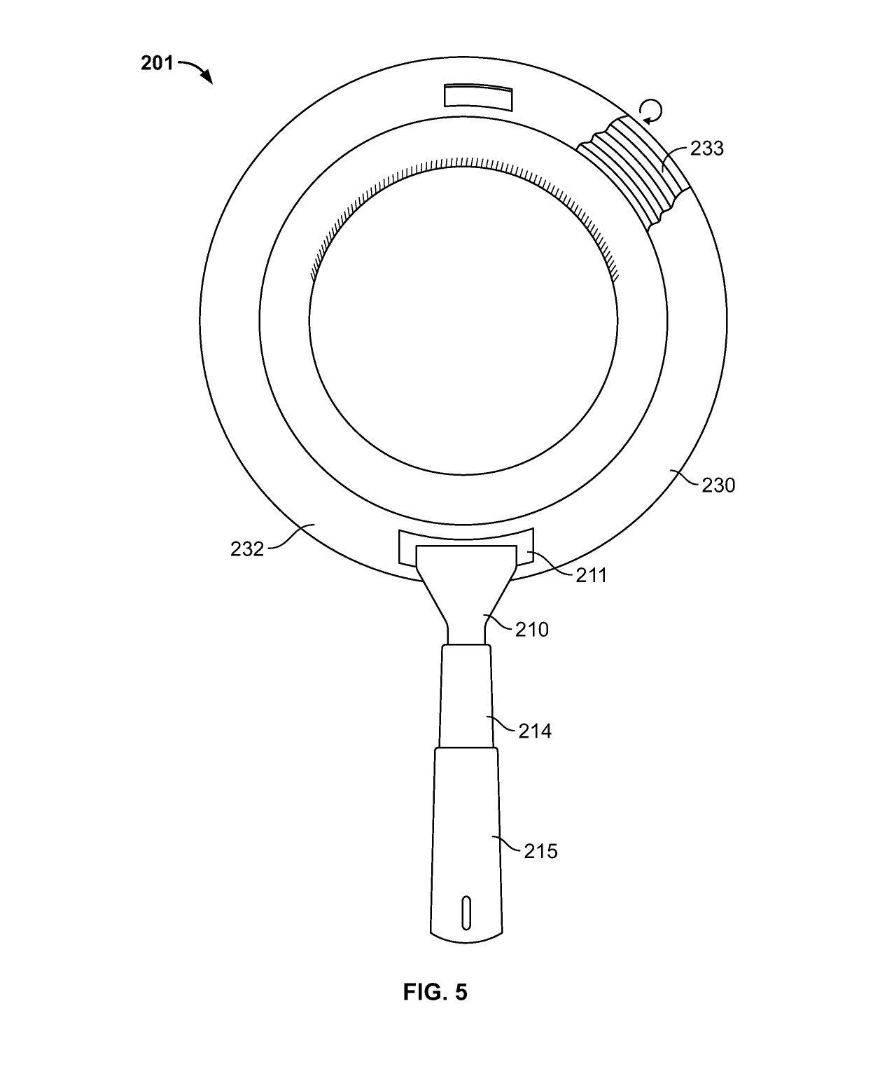

FIG. 5 illustrates another exemplary embodiment of a handle 201 embodying one or more aspects of the present disclosure. The handle 201 includes a quick release mechanism for securely attaching the handle 201 to the upper surface and the lower surface 233 of a gripping flare, flange, shoulder, or other portion 232 (e.g., curved portion around the perimeter, etc.) of the culinary vessel 230.

In this exemplary embodiment, the handle 201 includes a single upper pressure or clamping member 210 and a single lower pressure or clamping member. The upper and lower pressure or clamping members 210 (broadly, engagement members) may be operable for creating a singular clamping force point or area for securely attaching the handle 201 to the upper surface and lower surface 233 of a gripping flare, flange, shoulder, curved perimeter portion, or other portion of a culinary vessel 230. A gripping jaw includes or is defined by the upper and lower pressure or clamping members 210. The gripping jaw is relatively wide, e.g., wider than the a width of the body portion 214 and grip or handle portion 215, etc.

In this exemplary embodiment, the handle 201 includes one or more wide pads 211 disposed along the upper and lower pressure or clamping members 210. The pads 211 may have ridges and grooves similar to or substantially identical to the ridges and grooves described above for pads 11 shown in FIGS. 1 and 2.

FIG. 6 illustrates another exemplary embodiment of a handle 301 embodying one or more aspects of the present disclosure. The handle 301 includes a quick release mechanism (e.g., similar to a locking pliers or vise-grips, etc.) for securely attaching the handle 301 to a gripping flare, flange, shoulder, or other portion 332 (e.g., curved portion around the perimeter, etc.) of the culinary vessel 330.

The handle 301 includes pressure or clamping member 310, 312 positionable along respective upper and lower surfaces of the portion 332 of the culinary vessel 330. The upper and lower pressure or clamping members 310, 312 may be pivotably or rotatably coupled to the body portion 314, e.g., via rivets or other mechanical fasteners 317, etc.

Rivets 319 may also be used four pivotably or rotatably coupling other handle features, such as the trigger or lever 320, trigger release or lever 321, arm or bar 322. A bolt 324 may be used to adjust the spacing of the jaws, pressure or clamping members 310, 312. The lever 321 may be used to push the two parts or sides 314, 320 of the handle 301 apart. The handle 301 includes a spring member 318 and release trigger or lever 321 that assists the quick release action of the handle 301 from the culinary vessel 30.

In FIG. 6, the pressure or clamping member 310, 312 are shown clamped about the portion 332 of the culinary vessel 330 to thereby securely attach the handle 301 to the culinary vessel 330. A gripping jaw includes or is defined by the upper and lower pressure or clamping members 310, 310. As shown in FIG. 7, the gripping jaw is relatively wide, e.g., wider than the a width of the body portion 314 and grip or handle portion 315, etc.

The handle 301 includes pads 311 disposed along the upper and lower pressure or clamping members 311, 312. The pads 311 may have ridges and grooves similar to or substantially identical to the ridges and grooves described above for pads 11 shown in FIGS. 1 and 2.

The handle 301 includes a contact member or surface 316 (e.g., pad, etc.) at an end portion of a segment or arm 313. As shown in FIG. 6, the contact member 316 may be against an exterior surface of the culinary vessel 330 when the handle 310 is clamped onto the culinary vessel portion 332 (e.g., curved perimeter edge or other portion of a frying pan, etc.), to provide stability and additional leverage when the handle 301 is attached to a culinary vessel 330.

To attach the handle 301 to the culinary vessel 330, the grip 315 and lever 320 may be squeezed together by a user's single hand to thereby secure the handle 301 to the culinary vessel 330. The handle 301 is configured such that the user will advantageously hold the grip 315 and lever 320 closed while carrying the culinary vessel 330 via the handle 301, thus helping to inhibit or prevent an accidental release of the quick release mechanism and detachment of the handle 301 from the culinary vessel 330.

To release the lever 320, a user may move the release trigger 321 downward relative to the lever 320. The user may then push the two parts 314 and 320 apart to unclamp the handle 301 from the culinary vessel portion 332 and thereafter remove the handle 301 from the culinary vessel 330.

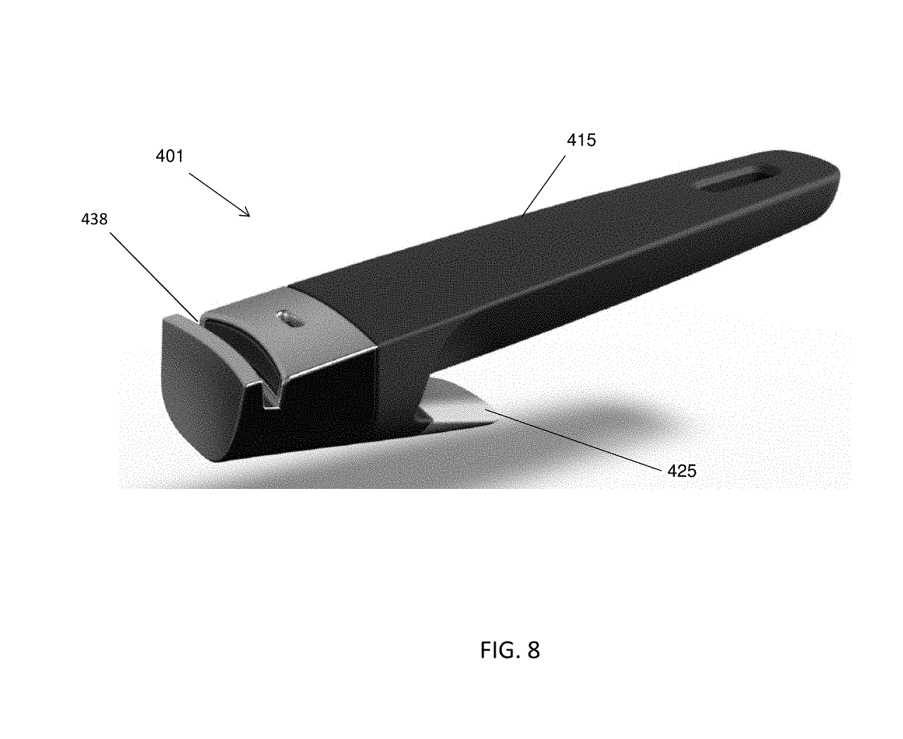

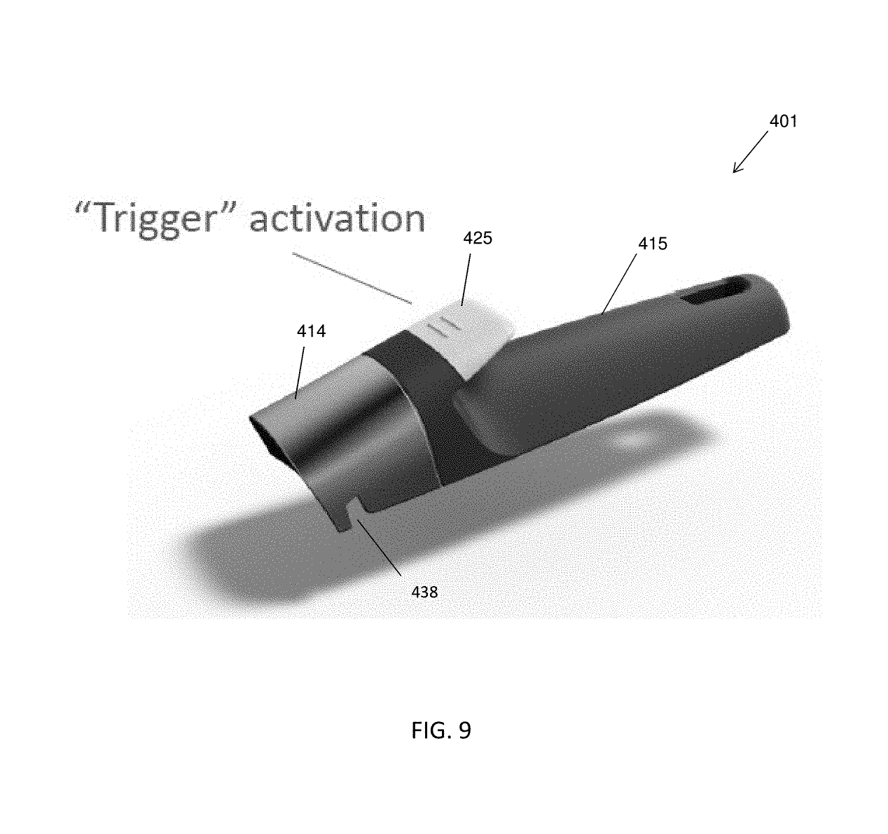

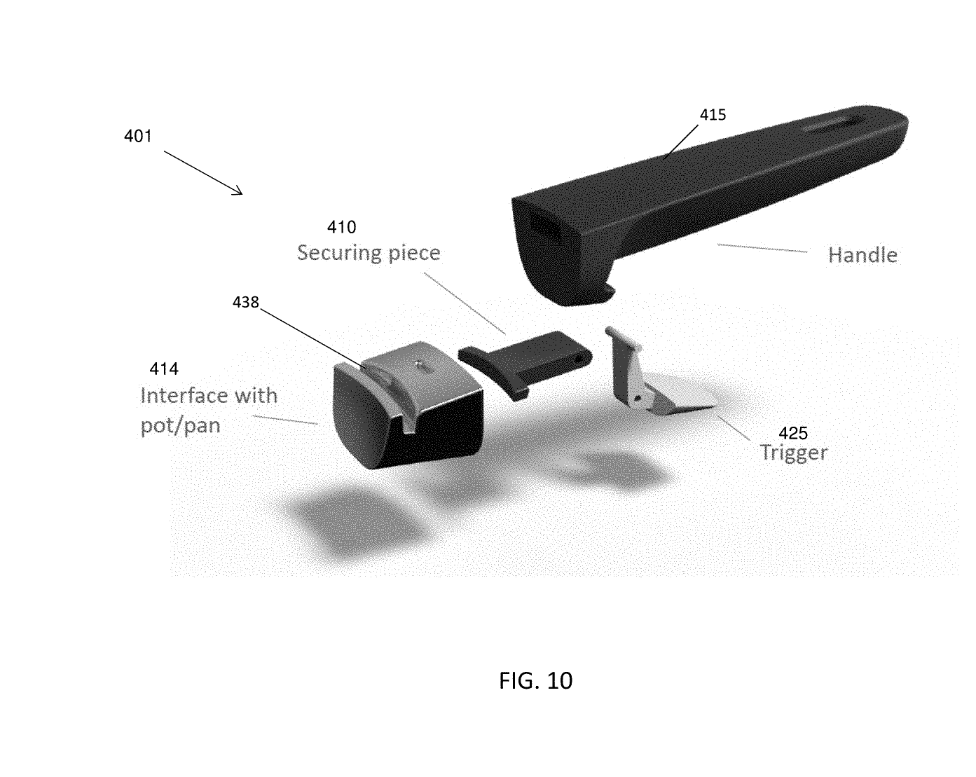

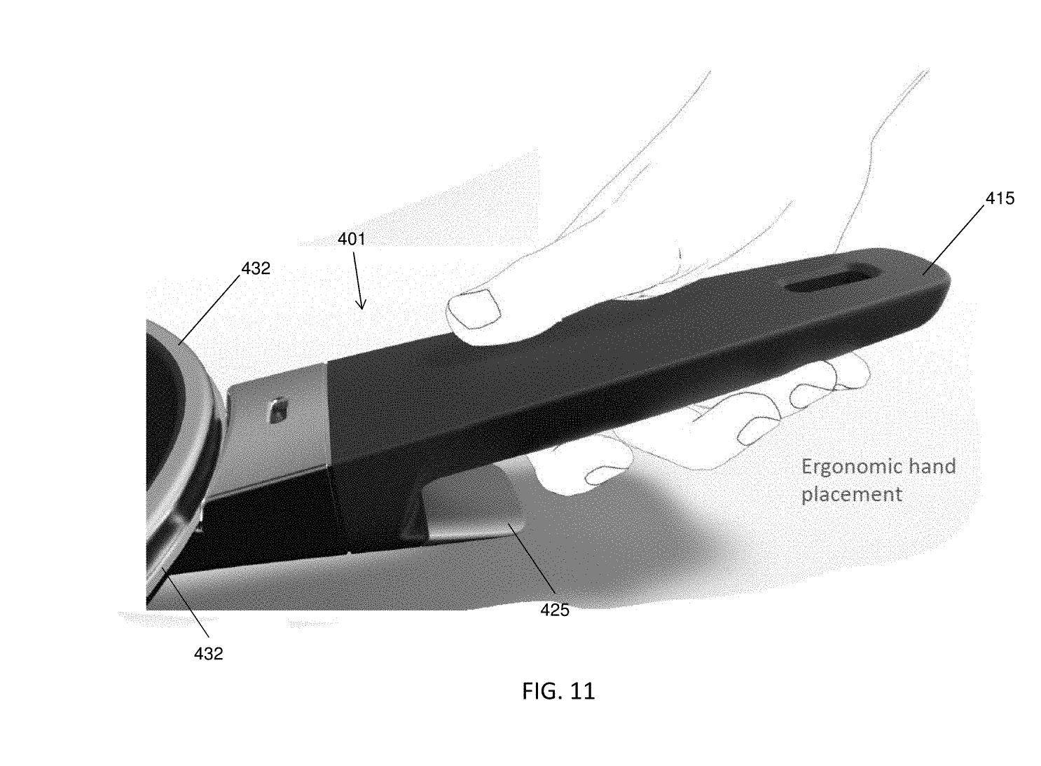

FIGS. 8 through 13B illustrate another exemplary embodiment of a handle 401 embodying one or more aspects of the present disclosure. The handle 401 includes a quick release mechanism for securely attaching the handle 401 to an edge portion, perimeter rim, or other portion 432 (e.g., curved portion around the perimeter, etc.) of a culinary vessel 430. As shown in FIG. 10, the handle 401 includes an interface 414, a trigger or lever 425 (e.g., finger activatable trigger, etc.), a securing piece 410, and a grip or handle portion 415.

To attach the handle 401 onto the culinary vessel 430, the rim 432 of the culinary vessel 430 is positioned within the slot 438 of the handle 401. Then, the grip 415 and lever 425 may be squeezed together by a user's single hand to thereby move the trigger or lever 425 to cause sliding movement of the securing piece 410. The securing piece 410 may then lockingly engage the rim 432 of the culinary vessel 430 to thereby securely attach the handle 401 to the culinary vessel 430. The handle 401 is configured such that the user will advantageously hold the grip 415 and trigger or lever 425 closed while carrying the culinary vessel 430 via the handle 401, thus helping to inhibit or prevent an accidental release of the quick release mechanism and detachment of the handle 401 from the culinary vessel 430. In addition, the handle 401 may be attached anywhere along the circumference of the portion 432 of the culinary vessel 430 in this example.

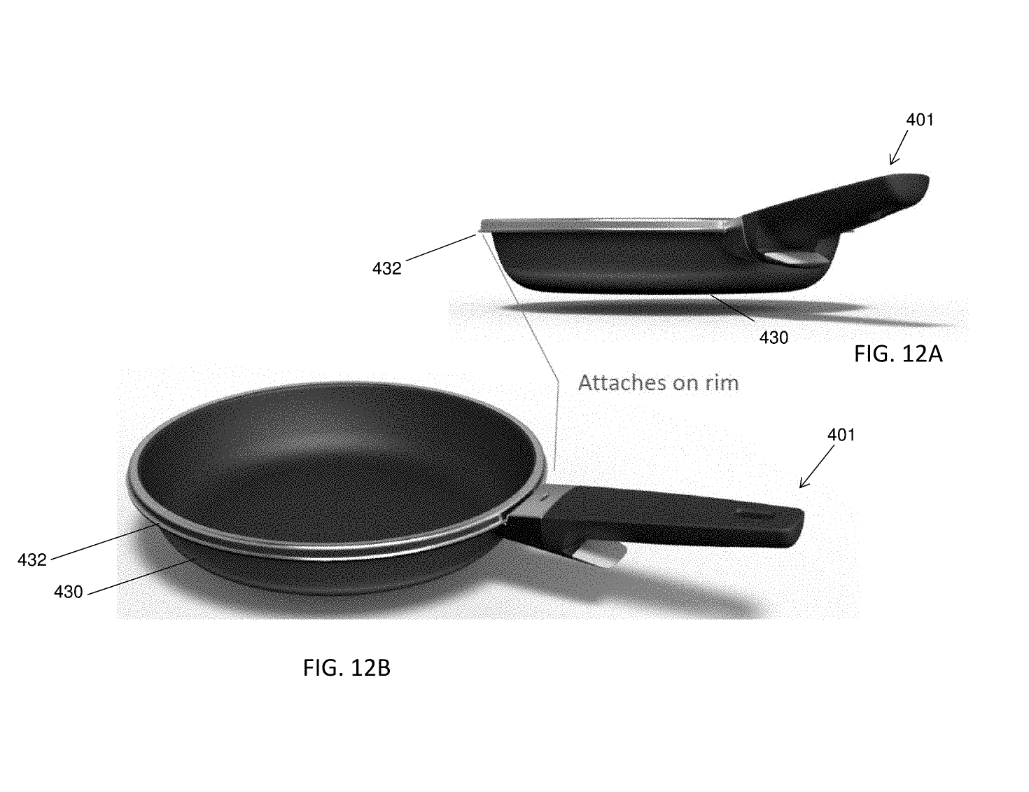

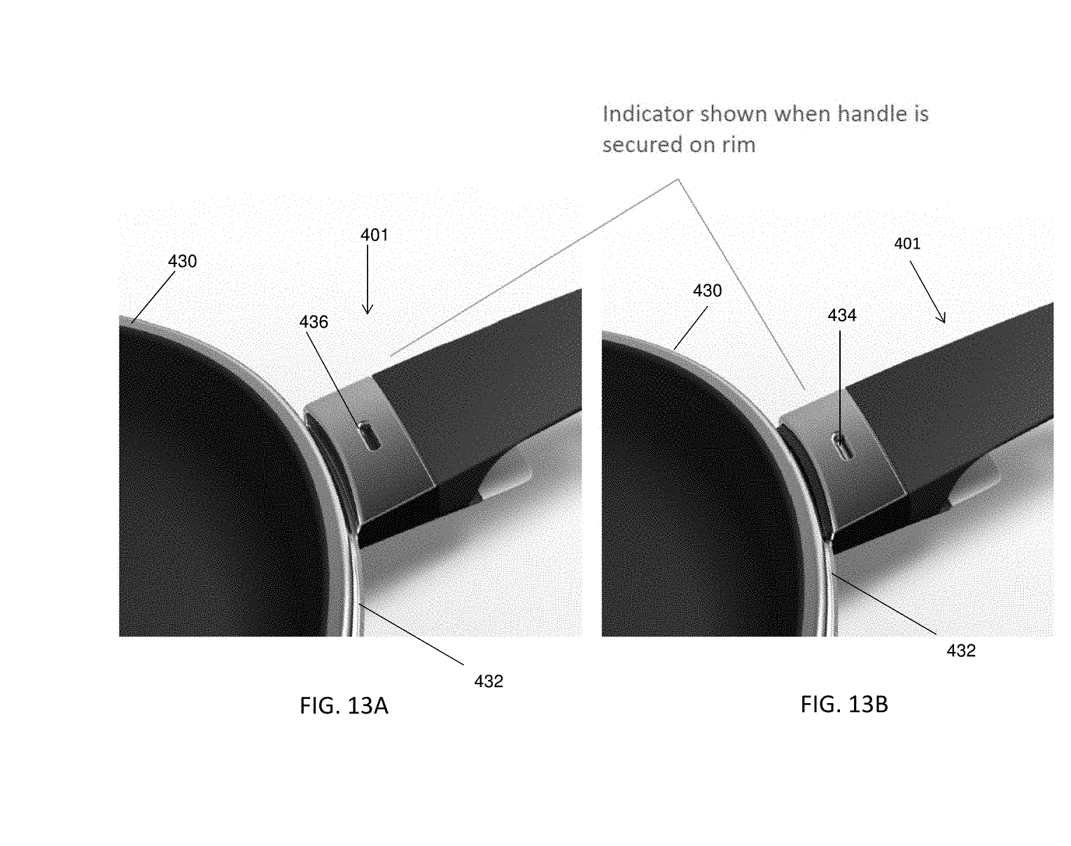

As shown in FIGS. 13A and 13B, the handle 401 includes an indicator 434 for indicating when the handle 401 is secured onto the rim 432 of the culinary vessel 430. In FIG. 13A, the indicator 434 is not visible thereby indicating to a user that the handle 401 is not securely attached to the culinary vessel 430. In FIG. 13B, the indicator 434 is visible through the opening 436 in the handle 401 thereby indicating to the user that the handle 401 is securely attached to the culinary vessel 430. In this exemplary embodiment, the indicator 434 includes an upper portion of the trigger or lever 425, which is preferably a different color than the interface 414 to make it readily detectable through the opening 436.

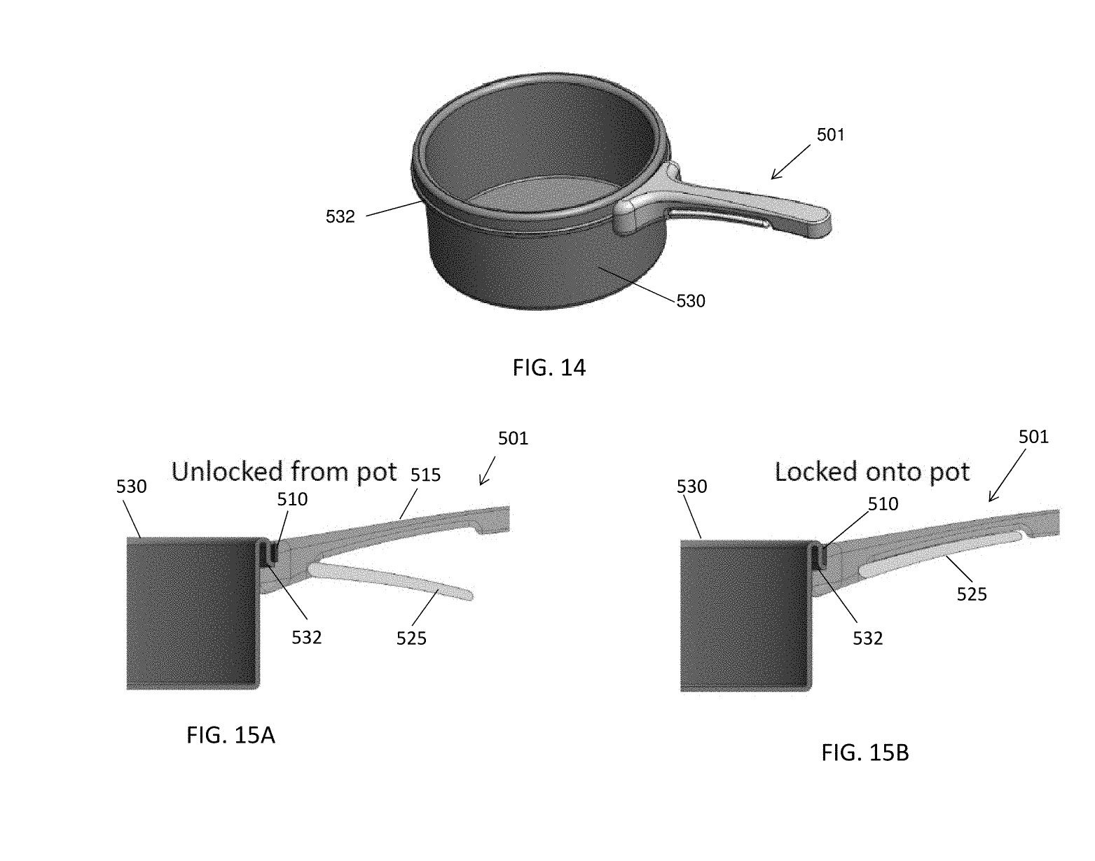

FIG. 14 illustrates another exemplary embodiment of a handle 501 embodying one or more aspects of the present disclosure. The handle 501 includes a quick release mechanism for securely attaching the handle 501 to an overhanging lip or other portion 532 of a pot or other culinary vessel 530.

By way of example, the handle 501 may be attached to a pot. The handle 501 may be configured to allow pourability from the pot.

The handle 501 is configured with a streamlined ergonomic grip or handle portion 515 and a trigger locking mechanism 525 (e.g., lever, finger activatable trigger, etc.). FIG. 15A shows the handle 501 in an open or unlocked condition in which the handle 501 is unlocked or unlatched from the pot 530 and the trigger or lever 525 is not activated, e.g., the handle portion 515 and lever 525 are not squeezed together by a user's hand, etc. FIG. 15B shows the handle 501 in a closed or locked condition in which the trigger 525 is activated (e.g., the handle portion 515 and lever 525 are squeezed together) and the handle 501 is locked onto the pot 530. During use, the handle 501 may be operable for transferring pick up forces to the surface of the pot or other culinary vessel 530.

To attach the handle 501 onto the culinary vessel 530, the overhanging lip 532 of the culinary vessel 530 is positioned within a slot defined generally between a front portion of the handle 501 and a securing piece 510. Then, the grip 515 and lever 525 may be squeezed together by a user's single hand to thereby cause the securing piece 510 to move or slide forward towards the overhanging lip 530 of the culinary vessel 530. The overhanging lip 530 may then be lockingly engaged within the slot and clamped between the securing piece 510 and the front portion of the handle 501. The handle 501 is configured such that the user will advantageously hold the grip 515 and trigger or lever 525 closed while carrying the culinary vessel 530 via the handle 501, thus helping to inhibit or prevent an accidental release of the quick release mechanism and detachment of the handle 501 from the culinary vessel 530. In addition, the handle 501 may be attached anywhere along the circumference of the portion 532 of the culinary vessel 530 in this example.

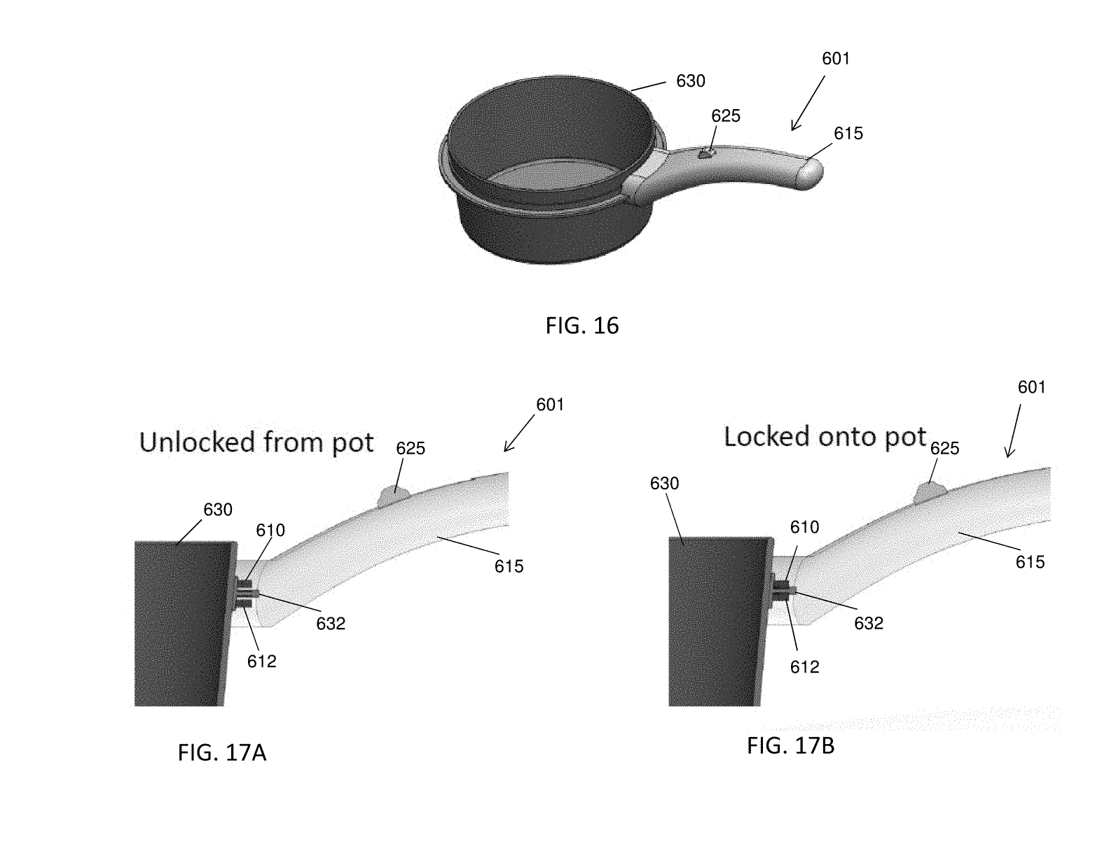

FIG. 16 illustrates another exemplary embodiment of a handle 601 embodying one or more aspects of the present disclosure. The handle 601 includes a quick release mechanism for securely attaching the handle 601 to a portion 632 of a pot or other culinary vessel 530.

By way of example, the handle 501 may be attached to a pot. The handle 501 may be configured to allow pourability from the pot.

The handle 601 is configured with an ergonomic grip or handle portion 615 and a switch lock mechanism 625 (e.g., finger slidable trigger, etc.). FIG. 17A shows the handle 601 in an open or unlocked condition in which the handle 601 is unlocked or unlatched from the pot 630 and the slide switch or trigger 625 is not activated. FIG. 17B shows the handle 601 in a closed or locked condition in which the slide switch or trigger 625 is activated and the handle 601 is locked onto the pot 630. During use, the handle 601 may be operable for transferring pick up forces to the surface of the pot or other culinary vessel 630.

To attach the handle 601 onto the culinary vessel 630, the outwardly protruding portion 632 of the culinary vessel 630 is positioned within a slot defined generally between upper and lower pressure members, clamping members, or securing pieces 610, 612. Then, the user may use a thumb to slide the switch 625 downward along the grip or handle portion 615. Sliding the switch 625 causes the securing pieces 610, 612 to move towards each other such that the portion 632 of the culinary vessel 630 is clamped and secured between the pieces 610, 612. The handle 601 is configured such that the user's hand may advantageously be positioned over the switch 625 and help hold the switch 625 stationary when carrying the culinary vessel 630 via the handle 601, thus helping to inhibit or prevent an accidental release of the quick release mechanism and detachment of the handle 601 from the culinary vessel 630. In addition, the handle 601 may be attached anywhere along the circumference of the portion 632 of the culinary vessel 630 in this example.

Accordingly, disclosed are exemplary embodiments of quick release detachable handles for culinary vessels. Also disclosed are exemplary embodiments of culinary vessels that include quick release detachable handles.

In an exemplary embodiment, a quick release detachable handle for a culinary vessel comprises a handle portion and a quick release mechanism for attaching and detaching the handle to/from the culinary vessel. The quick release mechanism includes a gripping jaw defined by or including one or more clamping members configured to clamp a portion of the culinary vessel to thereby attach the handle to the culinary vessel. The gripping jaw may be wider than a width and/or length of the handle portion. One or more pads may be along the one or more clamping members. The one or more pads may have a pattern of ridges and grooves that correspond with a pattern of grooves and ridges along the portion of the culinary vessel. Engagement of the ridges and grooves of the one or more pads respectively with the corresponding grooves and ridges along the portion of the culinary vessel may enable a more secure attachment of the handle to the culinary vessel. The handle may be configured such that carrying the culinary vessel by the handle helps maintain the quick release mechanism in a locked condition, thereby helping to inhibit an accidental release of the quick release mechanism and accidental detachment of the handle from the culinary vessel.

The one or more clamping members may comprise upper and lower clamping members. The one or more pads may comprise upper and lower pads respectively along upper and lower clamping members. The upper and lower pads may have patterns of ridges and grooves that correspond with pattern of grooves and ridges along upper and lower surfaces of the portion of the culinary vessel. Engagement of the ridges and grooves of the upper and lower pads respectively with the corresponding grooves and ridges along the upper and lower surfaces of the portion of the culinary vessel may enable a more secure attachment of the handle to the culinary vessel.

The quick release mechanism may include a lever configured to be movable or activatable when the handle portion and lever are pressed or squeezed together. One or more clamping or securing pieces may be movable by the lever between an unlocked condition and a locked condition. In the unlocked condition, the portion of the culinary vessel is not clamped by the one or more clamping pieces and the handle is detachable from the culinary vessel. In the locked condition, the portion of the culinary vessel is clamped by the one or more clamping pieces such that the handle is attached to the culinary vessel.

The handle is configured to be held by the user with the handle portion and the lever remaining pressed or squeezed together while the culinary vessel is being carried via the handle, thereby helping to inhibit an accidental release of the quick release mechanism and accidental detachment of the handle from the culinary vessel.

The handle may include a visual indicator for indicating the unlocked condition and the locked condition.

The quick release mechanism may include a slide member slidable along the handle portion. One or more clamping or securing pieces may be movable by the slide member between an unlocked condition and a locked condition. In the unlocked condition, the portion of the culinary vessel is not clamped by the one or more clamping pieces and the handle is detachable from the culinary vessel. In the locked condition, the portion of the culinary vessel is clamped by the one or more clamping pieces such that the handle is attached to the culinary vessel.

A culinary vessel may include the handle, which may be attachable anywhere along a circumference of the portion of the culinary vessel.

A system may include a plurality of culinary vessels having different configurations and one or more of the handles that are interchangeable or selectively usable with any one of the plurality of culinary vessels. The plurality of culinary vessels, with the one or more handles removed, may be configured to be stackable in an arrangement in which a largest culinary vessel of the plurality of culinary vessels is on bottom and a smallest culinary vessel of the plurality of culinary vessels is on top.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A quick release detachable handle for a culinary vessel, the handle comprising:
a handle portion; and
a quick release mechanism for attaching and detaching the handle to/from the culinary vessel, the quick release mechanism including a gripping jaw defined by or including one or more clamping members configured to clamp a portion of the culinary vessel to thereby attach the handle to the culinary vessel;
wherein:
the gripping jaw is wider than a width and/or length of the handle portion; and/or
one or more pads are along the one or more clamping members, the one or more pads having a pattern of ridges and grooves that correspond with a pattern of grooves and ridges along the portion of the culinary vessel, whereby engagement of the ridges and grooves of the one or more pads respectively with the corresponding grooves and ridges along the portion of the culinary vessel enable a more secure attachment of the handle to the culinary vessel; and/or
the handle is configured such that carrying the culinary vessel by the handle helps maintain the quick release mechanism in a locked condition, thereby helping to inhibit an accidental release of the quick release mechanism and accidental detachment of the handle from the culinary vessel.

2. The handle of claim 1, wherein:
the gripping jaw is wider than a width and/or length of the handle portion; and
the one or more clamping members comprise upper and lower clamping members, and the one or more pads comprise upper and lower pads respectively along upper and lower clamping members, the upper and lower pads having patterns of ridges and grooves that correspond with pattern of grooves and ridges along upper and lower surfaces of the portion of the culinary vessel, whereby engagement of the ridges and grooves of the upper and lower pads respectively with the corresponding grooves and ridges along the upper and lower surfaces of the portion of the culinary vessel enable a more secure attachment of the handle to the culinary vessel; and
the handle is configured such that carrying the culinary vessel by the handle helps maintain the quick release mechanism in a locked condition, thereby helping to inhibit an accidental release of the quick release mechanism and accidental detachment of the handle from the culinary vessel.

3. The handle of claim 1, wherein:
the one or more clamping members comprise upper and lower clamping members; and
the one or more pads comprise upper and lower pads respectively along the upper and lower clamping members, the upper and lower pads having patterns of ridges and grooves that correspond with pattern of grooves and ridges along upper and lower surfaces of the portion of the culinary vessel, whereby engagement of the ridges and grooves of the upper and lower pads respectively with the corresponding grooves and ridges along the upper and lower surfaces of the portion of the culinary vessel enable a more secure attachment of the handle to the culinary vessel.

4. The handle of claim 1, wherein the handle is configured such that carrying the culinary vessel by the handle helps maintain the quick release mechanism in a locked condition, thereby helping to inhibit an accidental release of the quick release mechanism and accidental detachment of the handle from the culinary vessel.

5. The handle of claim 1, wherein:
the quick release mechanism includes a lever configured to be movable or activatable when the handle portion and lever are pressed or squeezed together; and
the one or more clamping pieces are movable by the lever between:
an unlocked condition in which the portion of the culinary vessel is not clamped by the one or more clamping pieces and the handle is detachable from the culinary vessel; and
a locked condition in which the portion of the culinary vessel is clamped by the one or more clamping pieces such that the handle is attached to the culinary vessel.

6. The handle of claim 5, wherein the handle is configured to be held by a user with the handle portion and the lever remaining pressed or squeezed together while the culinary vessel is being carried via the handle, thereby helping to inhibit an accidental release of the quick release mechanism and accidental detachment of the handle from the culinary vessel.

7. The handle of claim 5, wherein the handle further comprises a visual indicator for indicating the unlocked condition and the locked condition.

8. The handle of claim 1, wherein:
the quick release mechanism includes a slide member slidable along the handle portion; and
the one or more clamping pieces are movable by the slide member between:
an unlocked condition in which the portion of the culinary vessel is not clamped by the one or more clamping pieces and the handle is detachable from the culinary vessel; and
a locked condition in which the portion of the culinary vessel is clamped by the one or more clamping pieces such that the handle is attached to the culinary vessel.

9. The handle of claim 1, wherein the gripping jaw is wider than the width of the handle portion.

10. The handle of claim 1, wherein the gripping jaw is wider than the length of the handle portion.

11. A culinary vessel including the handle of claim 1, wherein the handle is attachable anywhere along a circumference of the portion of the culinary vessel.

12. A system including a plurality of culinary vessels having different configurations and one or more of the handles of claim 1, wherein the one or more handles are interchangeable or selectively usable with any one of the plurality of culinary vessels.

13. The system of claim 12, wherein the plurality of culinary vessels, with the one or more handles removed, are configured to be stackable in an arrangement in which a largest culinary vessel of the plurality of culinary vessels is on bottom and a smallest culinary vessel of the plurality of culinary vessels is on top.

14. A quick release detachable handle for a culinary vessel, the handle comprising:
a handle portion; and
a quick release mechanism for attaching and detaching the handle to/from the culinary vessel;
wherein the handle is configured such that carrying the culinary vessel by the handle helps maintain the quick release mechanism in a locked condition, thereby helping to inhibit an accidental release of the quick release mechanism and accidental detachment of the handle from the culinary vessel.

15. The handle of claim 14, wherein the quick release mechanism includes:
a lever configured to be movable or activatable when the handle portion and lever are pressed or squeezed together; and
one or more securing pieces movable by the lever between:
an unlocked condition in which a portion of the culinary vessel is not clamped by the one or more securing pieces and the handle is detachable from the culinary vessel; and
a locked condition in which the portion of the culinary vessel is clamped by the one or more securing pieces such that the handle is attached to the culinary vessel.

16. The handle of claim 15, wherein the handle is configured to be held by a user with the handle portion and the lever remaining pressed or squeezed together while the culinary vessel is being carried via the handle, thereby helping to inhibit an accidental release of the quick release mechanism and accidental detachment of the handle from the culinary vessel.

17. The handle of claim 15, wherein the handle further comprises a visual indicator for indicating the unlocked condition and the locked condition.

18. The handle of claim 14, wherein the quick release mechanism includes:
a slide member slidable along the handle portion; and
one or more securing pieces movable by the slide member between:
an unlocked condition in which a portion of the culinary vessel is not clamped by the one or more securing pieces and the handle is detachable from the culinary vessel; and
a locked condition in which the portion of the culinary vessel is clamped by the one or more securing pieces such that the handle is attached to the culinary vessel.

19. A culinary vessel including the handle of claim 14 attachable anywhere along a circumference of a portion of the culinary vessel.

20. A system including a plurality of culinary vessels having different configurations and one or more of the handles of claim 14, wherein the one or more handles are interchangeable or selectively usable with any one of the plurality of culinary vessels, and wherein the plurality of culinary vessels, with the one or more handles removed, are configured to be stackable in an arrangement in which a largest culinary vessel of the plurality of culinary vessels is on bottom and a smallest culinary vessel of the plurality of culinary vessels is on top.
